(19) United States
(12) Patent Application Publication
(10) Pub. No.: US 2011/0089649 A1
(43) Pub. Date: Apr. 21, 2011

(54) STRUT FOR SKI ASSEMBLY

(76) Inventor: Robert A. Wrightman, Bracebridge (CA)

(21) Appl. No.: 12/906,776

(22) Filed: Oct. 18, 2010

Related U.S. Application Data
(60) Provisional application No. 61/252,411, filed on Oct. 16, 2009.

(51) Int. Cl. B62B 17/02; B23P 17/00

(52) U.S. Cl. 280/28; 29/401.1

(57) ABSTRACT

A strut to connect a ski assembly to a snowmobile suspension comprising a spindle having at least one attachment point to secure the spindle to suspension components and having a first abutment face. A saddle assembly extending from the spindle for connection to the ski assembly and having a second abutment face oppositely directed to the first abutment face. A connector to hold the abutment faces in engagement to provide a unitary strut.

### CROSS REFERENCE TO RELATED APPLICATIONS

This application claims priority from U.S. Provisional Application No. 61/252,411 filed on Oct. 16, 2009; the contents of which are incorporated herein by reference.

### FIELD OF THE INVENTION

The present invention relates to a strut for use with a ski assembly of a snowmobile.

### SUMMARY OF THE INVENTION

It is well known that snowmobiles utilize a pair of ski assemblies at the forward end of the vehicle and are driven by an endless belt positioned at the rear of the vehicle. The ski assemblies are steerable by the operator so that the vehicle may be moved in the desired direction. As the performance of the snowmobile is increased, the handling characteristics of the ski assemblies have become more critical.

In Canadian Patent 2,604,041, commonly owned with the present application and the contents of which are incorporated by reference, there is a disclosed a ski assembly including a bifurcated ski formed by a pair of rails that are laterally spaced from one another and connected at the tip to provide a unitary construction. The ski is mounted on a strut that includes a pair of laterally spaced legs, each connected to a respective one of the rails, so that snow may pass between the rails and bifurcated legs to allow free passage of the ski assembly. It has been found that the ski assembly disclosed in the above referenced patent offers superior performance in certain snow conditions on a variety of different machines.

There are a number of different manufacturers of snowmobile and within each manufacturers range, there are a number of different models as snowmobile. As such, in order to enable the ski to be fitted to each snowmobile, it is necessary to make a strut that conforms to the individual requirements of each model. Different models will have different connection points for the suspension and different configurations of spindle that require replicating in a strut intended to connect a bifurcated ski to the snowmobile. The diversity of different models increases the complexity of supplying skis to the snowmobile industry and thereby increases the cost of manufacturer and distribution.

It is therefore an object of the present invention to obviate or mitigate the above disadvantages.

In general terms, the present invention provides a strut to connect a ski assembly to a snowmobile suspension. The strut comprises of a spindle having at least one attachment point to secure the spindle to the suspension components of snowmobile. The spindle has a first abutment face that is configured to abut a second abutment face on a saddle assembly. The saddle assembly extends from the spindle for connection to a ski assembly. A connector is provided to hold the abutment faces in engagement and provide, when assembled, a unitary strut.

Preferably, the saddle assembly includes a pair of legs, each adapted to be connected with a respective rail of a bifurcated ski.

### BRIEF DESCRIPTION OF THE DRAWINGS

Embodiments of the invention will now be described by way of example only with reference made to the accompanying drawings in which:

FIG. 1 is a perspective exploded view of a ski assembly for use on a snowmobile.

FIG. 2 is a side view of the ski assembly of FIG. 1 in an assembled condition.

FIG. 3 is a plan view of the ski assembly shown in FIG. 2.

FIG. 4 is a section on the line IV-IV of FIG. 3.

FIG. 5 is a plan view of strut shown in FIGS. 1 through 3.

FIG. 6 is a section on the line VI-VI of FIG. 5.

FIG. 7 is an exploded perspective view, similar to that of FIG. 1, of the strut of FIG. 5.

FIG. 8 is an enlarged perspective view of a component of the strut shown in FIG. 7.

FIG. 9 is a front elevation of the component shown in FIG. 8.

FIG. 10 is a plan view of FIG. 9.

FIG. 11 is a rear view of the component shown in FIG. 9.

FIG. 12 is a perspective view of a tool used to assemble the ski assembly of FIGS. 1 through 11.

FIG. 13 is an underside perspective view of the tool shown in FIG. 12.

FIG. 14 is a section on the line XIV-XIV of FIG. 12.

FIG. 15 is an exploded perspective view of a component used in the ski assembly shown in FIGS. 1 through 11.

FIG. 16 is a perspective of the component of FIG. 15 in an assembled condition.

FIG. 17 is a view on the line XVII-XVII of FIG. 4.

FIG. 18 is a view similar to FIG. 1 of a further embodiment of ski assembly.

FIG. 19 is a side view of the ski assembly of FIG. 18 when assembled.

FIG. 20 is a plan view of FIG. 19.

FIG. 21 is a section on the line XXI-XXI of FIG. 20.

FIG. 22 is an exploded perspective view of a strut used in the assembly of FIG. 18.

FIG. 23 is a exploded perspective view of a further embodiment of ski assembly.

FIG. 24 is a side elevation of the ski assembly of FIG. 23 when assembled.

FIG. 25 is a plan view of the ski assembly if FIG. 23.

FIG. 26 is a section on the line XXVI-XXVI of FIG. 25.

FIG. 27 is a perspective view of the strut used in the ski assembly of FIGS. 23 through 26.

### DETAILED DESCRIPTION OF THE INVENTION

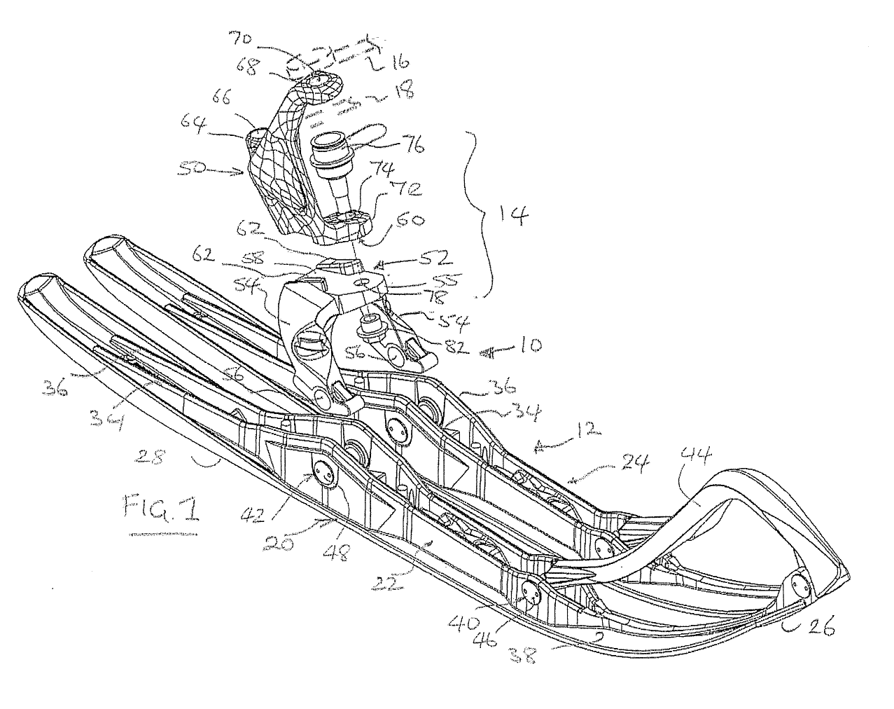

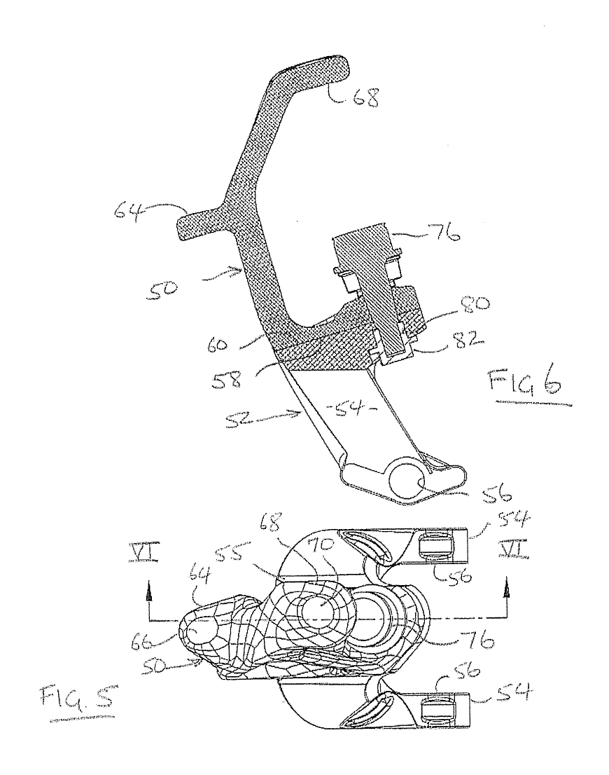

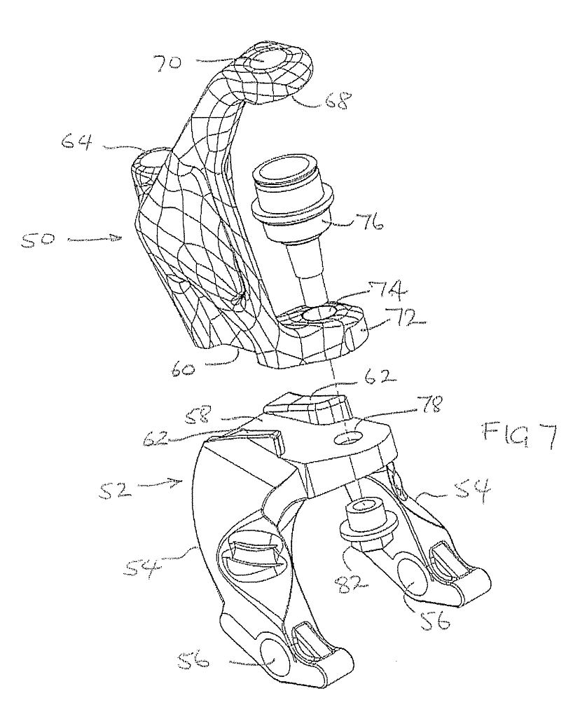

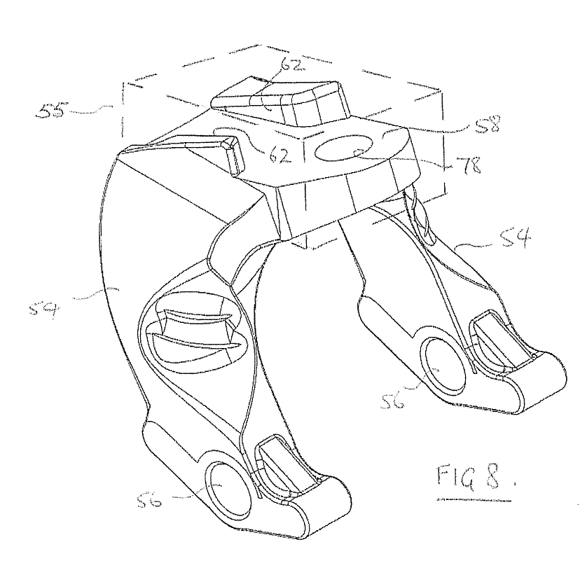

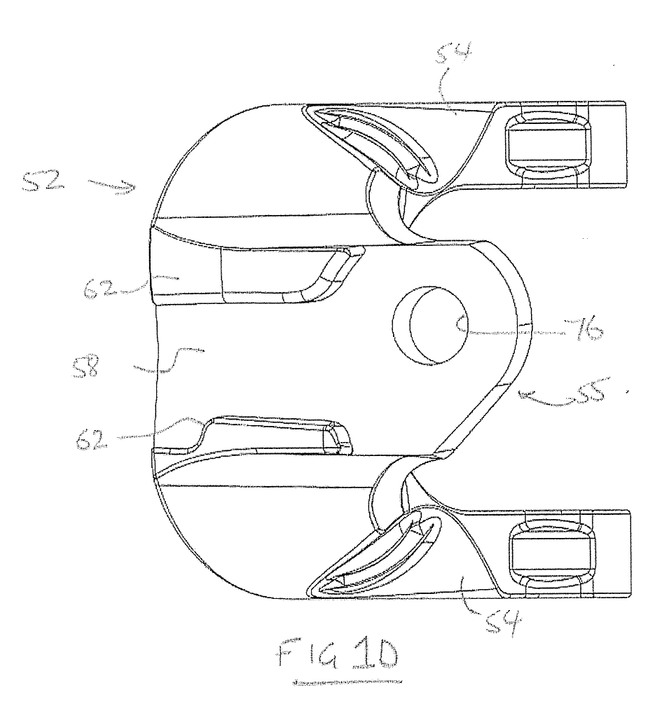

Referring therefore initially to the embodiments of FIGS. 1 through 11, a ski assembly generally indicated 10 includes a ski 12 and a strut 14. The strut 14 is connected to the snowmobile not shown through suspension and steering links 16, 18 respectfully shown in ghosted outline. It will be appreciated however that the suspension and steering links form part of the snowmobile rather than the ski assembly.

The ski 12 has a body 20 formed as a pair of rails 22, 24 respectively that are laterally spaced from one another and connected at the tip 26 to form a unitary construction. The ski 12 is moulded from plastics material having the requisite strength and flexibility.

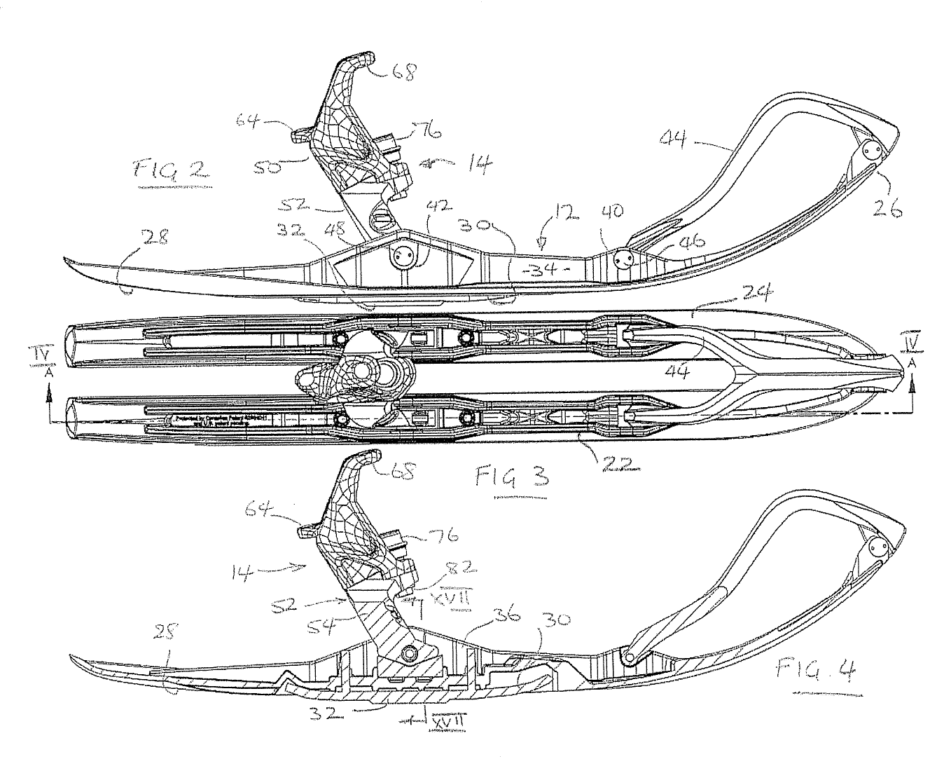

As can be seen in FIG. 2 each of the rails 22, 24 has an under surface 28 on which is mounted a runner 30. A carbide insert 32 provides a hardened surface for the runner 30.

As best seen in FIGS. 2-10 a pair of laterally spaced walls 34, 36 are formed on each of the rails 22, 24 and extend upwardly from the upper surface 38. The walls extend from adjacent the tip 26 to the rear of the rails and provide a pair of connection points 40, 42 at longitudinally spaced locations. The connection point 40 receives a stabilizer bar 44 that is located between the walls 34, 36 of each of the rails 22, 24 and is also pivotally connected to the tip 26. The stabilizer bar 44 is connected through shoulder bolts 46 described in greater detail below.

Connection point 42 serves to connect the strut 14 to the ski 12 using shoulder bolts 48, also described in greater detail below. The strut 14 is formed with a spindle 50 and a saddle 52. The saddle 52 has a pair of laterally spaced legs 54, each of which is received between the walls 34, 36 of a respective one of the rails 22, 24. The legs 54 have a lateral bore 56 to receive the shoulder bolt 48 and pivotally connect the leg 54 to the rail 24. The legs 54 are connected by a platform 55 integrally formed with the legs 54.

The platform has an upwardly directed face 58 which provides an abutment surface for a downwardly directed face 60 on the spindle 50. The upwardly directed face 58 has a pair of upstanding cheeks 62 that provide lateral and longitudinal stops that conform to a portion of the periphery of the spindle 50.

The spindle 50 conforms to the configuration of the upper portion of the strut 14 utilized on the snowmobile to which the ski assembly 10 is to be fitted and in the embodiment shown in FIGS. 1 through 11 includes a steering arm 64 with a tapered bore 66 to receive a steering ball joint and an upper link mounting point 68 with a tapered bore 70 to receive the ball joint of the upper suspension link. The spindle 50 also includes a lower link mounting point 72 that has a tapered bore 74 to receive a ball joint 76 of the lower suspension link. The downwardly directed face 60 is generally planar so as to abut the upwardly directed face 58. A hole 78 is formed in the platform 55 extending between the legs 54 and aligned with the bore 74 to receive the threaded spindle of ball joint 76 connected to the lower suspension link. The hole 78 is counter bored, as indicated at 80 to receive a shouldered nut 82 which includes a thread complementary to that carried by the ball joint 76.

In order to prepare a ski assembly 10 for fitment to a snowmobile, the strut 14 is first assembled utilizing the spindle 50 appropriate for the particular snowmobile and a saddle 52 with abutments faces complementary to that of the selected spindle. In the embodiment shown in FIGS. 1 through 11, the spindle 50 is placed on the saddle 52 with the cheeks 62 snugly engaging the periphery of the lower portion of the spindle 50. The cheeks 62 cooperate with the spindle 50 to inhibit relative lateral and longitudinal motion between the spindle 50 and saddle 52.

The ball joint 76 is then inserted into the lower link mounting 72 and the nut 82 threaded onto the ball joint 76 to secure the faces 58, 60 in film engagement. When connected, the spindle 50 and saddle 52 form a unitary strut 14 with the cheeks 62 operable to transmit loads between the two components whilst inhibiting relative movement between them. In addition to or in place of the mechanical connection provided by the ball joint 76 and nut 82 it is possible to utilize an adhesive or bonding techniques to connect the spindle to the saddle. Alternatively the spindle and the saddle may be connected by a precision welding technique to form a unitary construction.

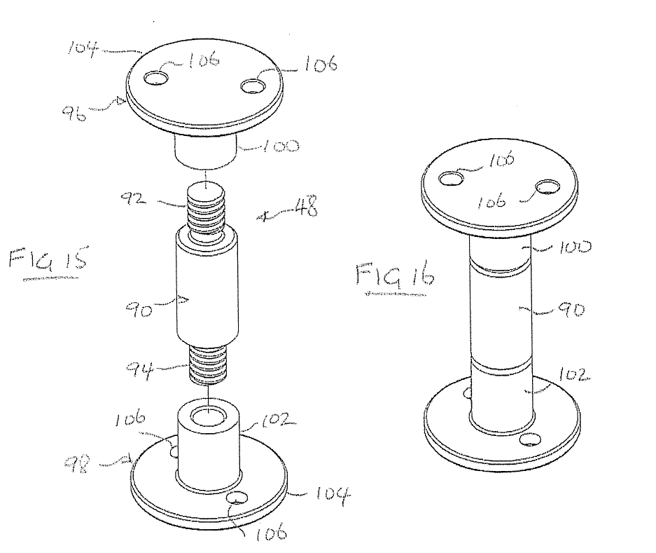

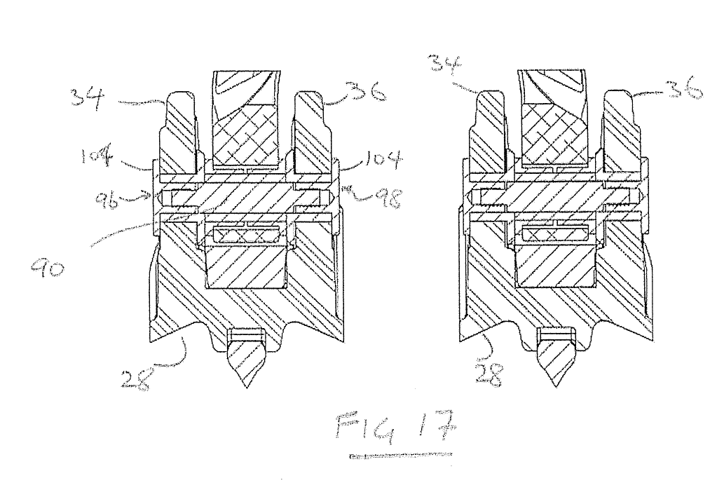

The strut 14 may then be assembled to the ski 12 using the shoulder bolts 48. The shoulder bolts 48 are shown in greater detail in FIGS. 15, 16 and 17 and include a central barrel portion 90 with oppositely directed threaded studs 92, 94. A pair of end caps 96, 98 have a boss 100, 102 respectfully that are threaded to receive the studs 92, 94. Each of the end caps 96, 98 has flange 104 extending radially beyond the boss 100, 102 with a pair of cylindrical recesses 106 at diametrically spaced locations to facilitate tightening the end caps 96, 98 to the studs 92, 94. It will be noted that the walls 34, 36 at the connection point 42 are relieved to provide a recess 106 that is the depth of the head 104 so that the wall and head provide a smooth surface.

The shoulder bolts 48 are similar in construction and are used to connect the stabilizer 44 to the rails.

To assemble the strut 14 to the ski 12 as can be seen from FIG. 1, the legs 54 are located between the walls 34, 36 at the connection points 42. The bore 56 is aligned with bores 43 in the wall 34, 36 and the barrel 90 inserted through the bores 43 and ball 56. The end caps 96, 98 are then threaded onto the studs 92, 94 with the heads 104 engaging the outer faces of the walls 34, 36.

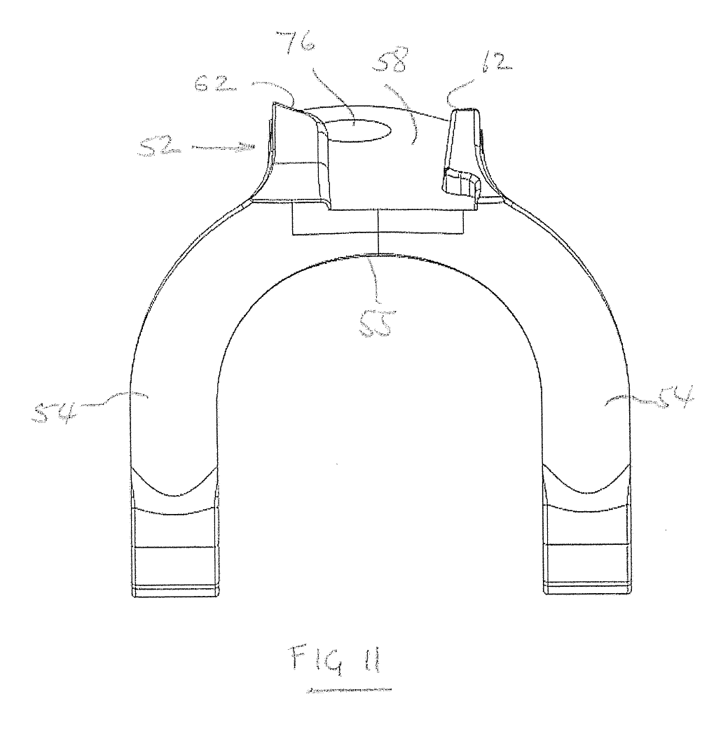

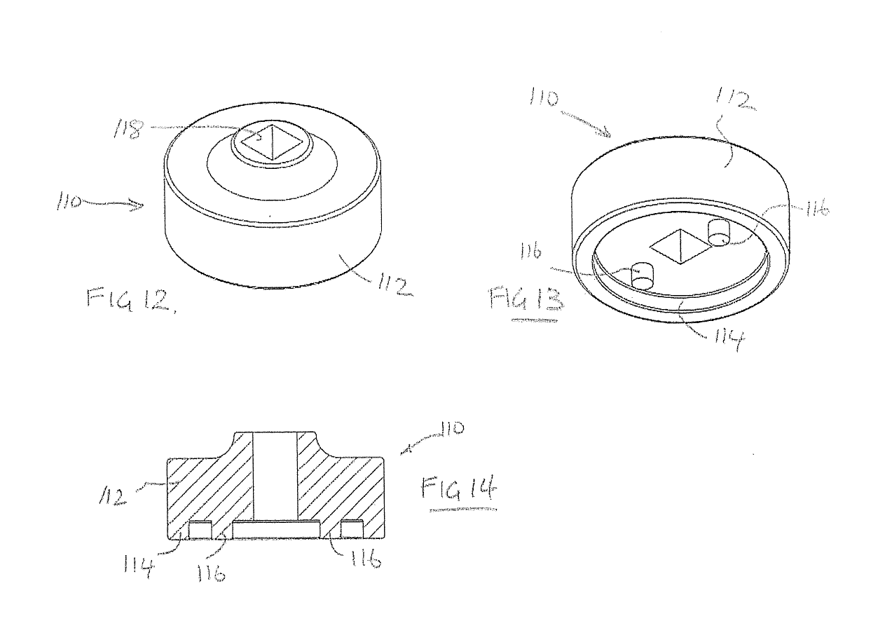

The end caps 96, 98 may be tightened or released on the studs 92, 94 using the tool shown in FIGS. 12 through 14. The tool 110 has a cylindrical body 112 with a peripheral skirt 114. The skirt is dimensioned to overlap the heads 104. A pair of pins 116 extend axially from the body 112 and are spaced to correspond with the recesses 106. A square section socket 118 is provided in the body to receive a wrench.

The tool 110 may simply be inserted over the head 104 with the pins 116 engaged in the recesses 106 and then tightened on the studs 92, 94. The heads 104 provide a relatively smooth outer surface to avoid entrapment of snow and the like in use.

The provision of a spindle 50 and the saddle 52 with the connection between the two components by way of the nut 82 enables the same saddle to be used on a variety of different vehicles, subject to the configuration of the cheeks 62 and the abutment faces 58, 60. This facilitates the manufacturer of the saddle which is common to a number of skis and allows the spindle to be customized to the particular vehicle.

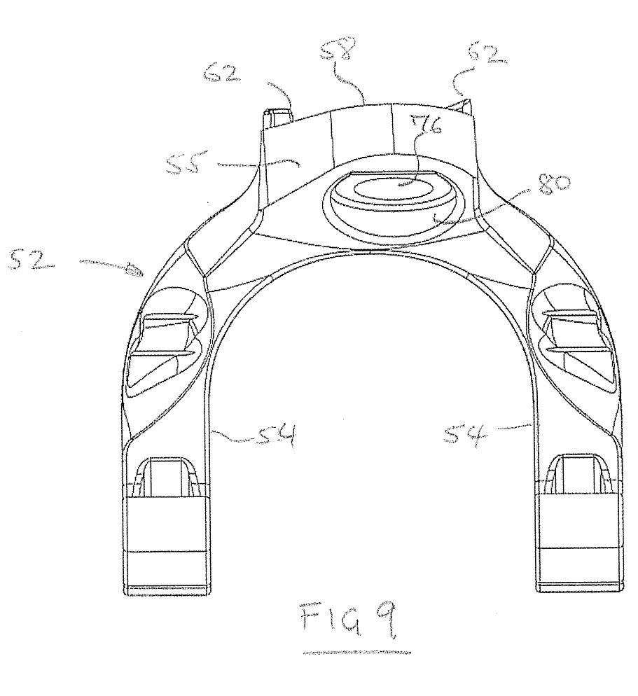

To further facilitate the provisioning of a number of different snowmobiles, the saddle 52 is initially formed as shown in FIG. 8, with an enlarged platform 55 as shown in ghosted outline in FIG. 8. The enlarged platform 55 provides surplus material which then may be machined to provide the particular configuration of the upwardly directed abutting surface 58 required for a particular spindle. Similarly, the spindle itself may be formed from the spindle associated with the particular snowmbobile which is cut at the desired plane to provide the downwardly directed abutment face 60. The lower portion normally associated with the connection to the standard ski is thus removed leaving the configuration of the attachment points to the suspension unchanged. A stock of saddles may then be configured to suit the particular struts required and minimize the inventory necessary to provide the strut 14.

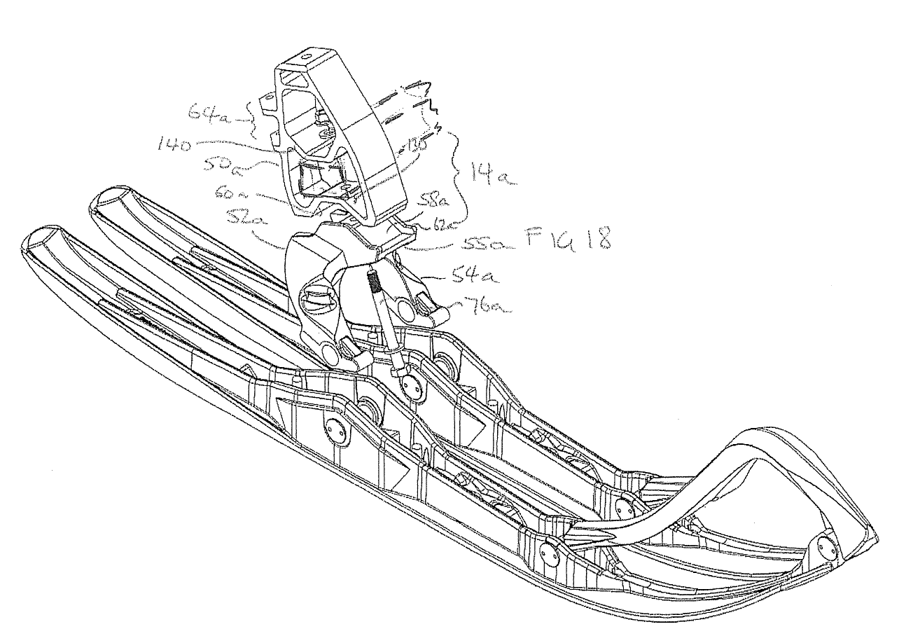

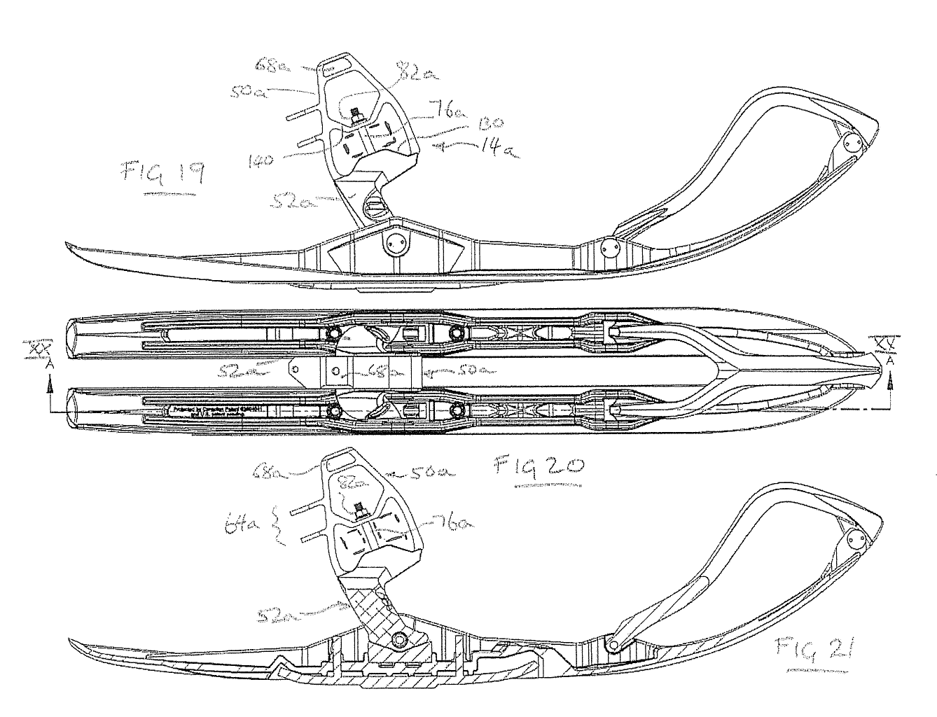

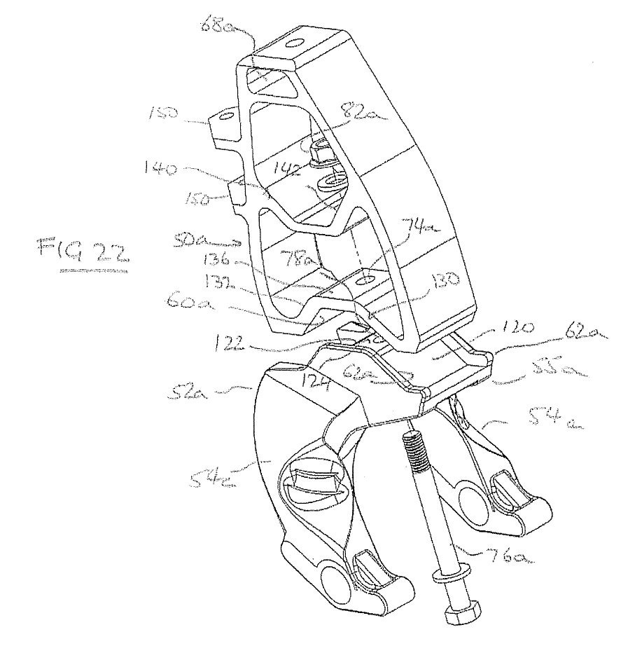

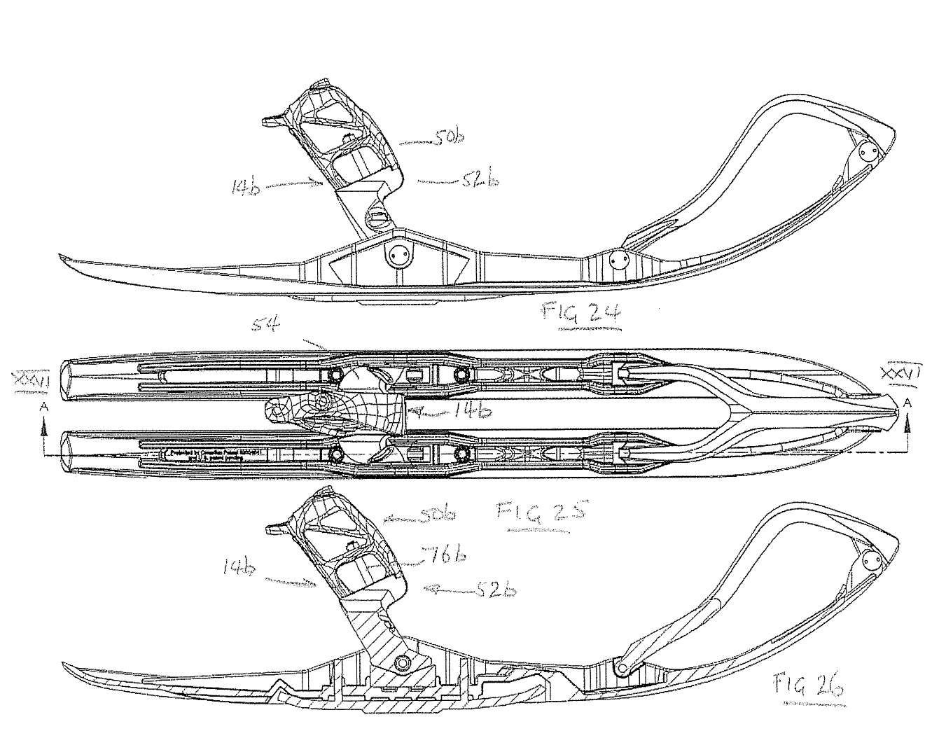

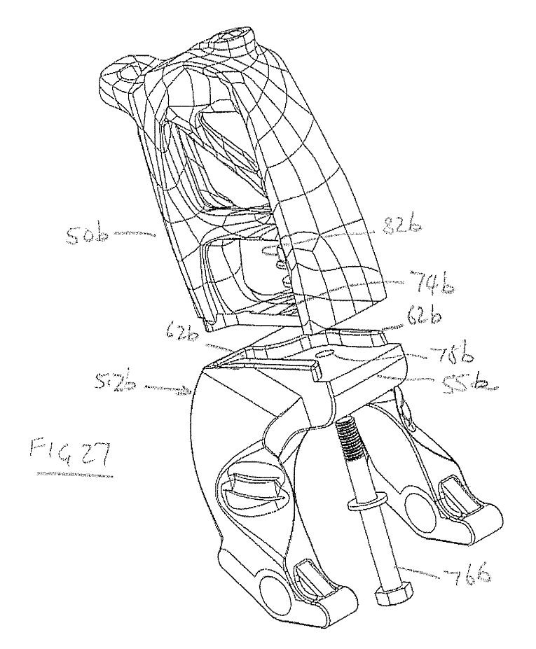

Examples of different embodiments provided in FIGS. 18 to 27 indicate the versatility of such an arrangement.

In the embodiment of FIGS. 18 to 22, like reference numerals will be used to denote like components with a suffix ‘a’ added for clarity. The strut 14a is formed from a spindle 50a and a saddle 52a. The legs 54a have a similar configuration to that shown in the previous embodiment but the platform 55a is configured to suit the configuration of the spindle 50a.

The upwardly directed abutment surface 58a has a pair of inclined portions 120, 122 connected by a raised portion 124 that are flanked by upstanding cheeks 62a. Hole 78a is formed in the raised portion 124 of the platform 50a between the cheeks 62a.

The spindle 50a has an open web design with a lower web 130 defining the downwardly directed abutment face 60a and having upwardly inclined portions 132 and a central web 136. A hole 74a is aligned with the hole 78a. A central web 140 likewise is provided with a central hole 142 and the space between the lower and central webs is dimensioned to receive a suspension strut. Ears 150 project rearwardly from the spindle 50a to provide a steering arm 64a. An upper pivot point 68a is provided at the apex of the spindle 50a to receive the upper suspension arm of the snowmobile which sits on top of the upper web.

A bolt 76a extends through the platform 55a and the lower and central webs to connect the spindle 50a to the lower suspension link indicated in ghosted outline. The bolt 76a defines a pivot access for the spindle relative to the suspension and is secured by nuts 82a. The bolt 76a and nut 82a ensure a rigid connection between the spindle 50a and saddle 52a with the cheeks 68a and inclined portions 120, 122, 132 providing longitudinal and lateral stops to inhibit relative movement between the spindle and saddle.

It will be appreciated that in this embodiment, the spindle 50a is formed by removing the lower portion of a standard spindle leaving the lower web exposed. The platform 55a is machined to be complementary to the lower web and therefore provide the abutment surfaces between the spindle and saddle. The normal functionality of the strut 14 is thus maintained whilst using original components from the snowmobile.

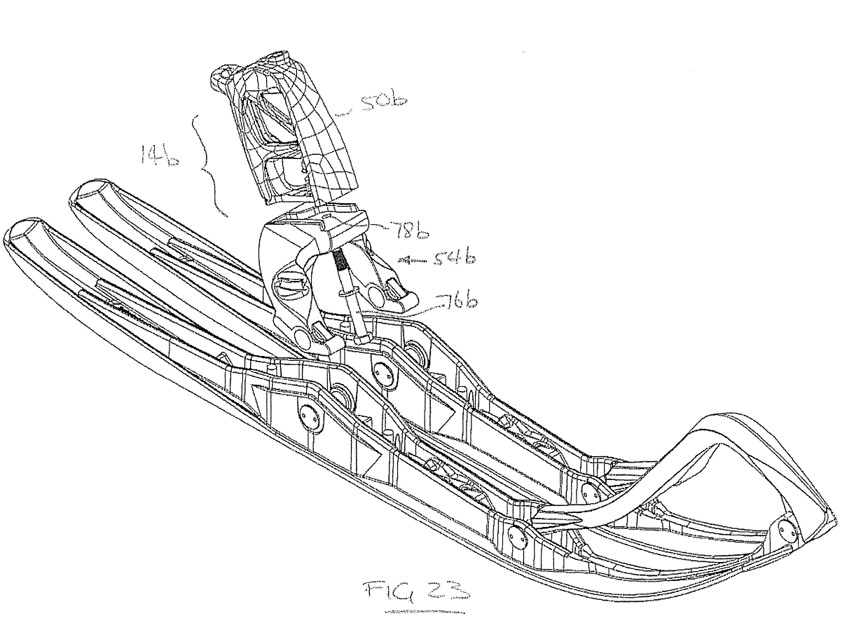

Similarly, in the embodiments of FIGS. 23 through FIG. 27 in which like reference numerals will be used to denote like components with a suffix ‘b’ added for clarity, the strut 14b is formed from a truncated spindle 50b who's lower portion is removed. Platform 55b is machined to provide cheeks 62b that snugly receive the lower periphery of the truncated spindle 50b. A bolt 76b passes through aligned bores 78b, 74b with a nut 82b to firmly secure the spindle to the saddle. Again therefore, a standard saddle 52b is utilized and a spindle 50b from the original suspension element is adapted for fitment onto the saddle.

In each case therefore, the suspension strut 14 is formed from a spindle and saddle that have respective abutting surfaces and are secured by a mechanical connector extending between the saddle and the spindle, or in the alternative by means of adhesive bonding or other connecting techniques or a combination of these connections.

Although the invention has been described with reference to certain specific embodiments, various modifications thereof will be apparent to those skilled in the art without departing from the spirit and scope of the invention as outlined in the claims appended hereto. The entire disclosures of all references recited above are incorporated herein by reference.

What is claimed is:

1. A strut to connect a ski assembly to a snowmobile suspension comprising:
a spindle having at least one attachment point to secure said spindle to suspension components, and having a first abutment face;
a saddle assembly extending from said spindle for connection to said ski assembly and having a second abutment face oppositely directed to said first abutment face; and
a connector to hold said abutment faces in engagement to provide a unitary strut.

2. A strut according to claim 1 one of said abutment faces has stops thereon to inhibit relative movement between said spindle and said saddle assembly.

3. A strut according to claim 2 wherein said stops inhibit relative lateral movement.

4. A strut according to claim 2 wherein said stops inhibit relative longitudinal movement.

5. A strut according to claim 2 wherein said stops are formed as upstanding cheeks operable to engage flanks of the other of said abutment faces to inhibit relative movement there between.

6. A strut according to claim 1 wherein said connector includes a mechanical connector to hold said abutment faces in contact.

7. A strut according to claim 6 wherein said mechanical connector connects said strut to a suspension element.

8. A strut according to claim 7 wherein said mechanical connector is a bolt extending through aligned bores in said abutment faces and secured by a nut.

9. A strut according to claim 6 wherein said mechanical connector is a ball joint assembly.

10. A strut according to claim 9 wherein said ball joint extends through aligned tapered holes in said abutment faces and is secured by a nut.

11. A strut according to claim 1 wherein said saddle assembly includes a pair of laterally spaced legs, each attached to ski assembly.

12. A strut assembly according to claim 11 wherein each of said legs has a lateral hole to receive a pivot pin and secure a ski assembly to said strut.

13. A method of converting a strut used to connect a suspension to a ski assembly said method comprising the steps of removing a lower portion of a spindle between attachment points of said spindle to said snowmobile suspension and attachment points of said spindle to said ski, to provide a first abutment face, providing a saddle having a second abutment face and an attachment point for attaching said saddle to a ski assembly, and
connecting said saddle to said spindle with said faces in abutment.

14. A method according to claim 13 including forming on one of said faces to inhibit relative movement between said spindle and said saddle.
